(19) United States
(12) Patent Application Publication
(10) Pub. No.: US 2012/0203758 A1
(43) Pub. Date: Aug. 9, 2012

(54) OPPORTUNITY IDENTIFICATION FOR SEARCH ENGINE OPTIMIZATION

(75) Inventors: JIMMY YU, FOSTER CITY, CA (US); SAMMY YU, SAN MATEO, CA (US); LEMUEL S. PARK, CERRITOS, CA (US); LENNON LIAO, SAN MATEO, CA (US); JOSHUA CROSSMAN, LOS ALTOS, CA (US); ROLLAND YIP, HONG KONG (HK)

(73) Assignee: BRIGHTEDGE TECHNOLOGIES, INC., SAN MATEO, CA (US)

(21) Appl. No.: 13/369,552

(22) Filed: Feb. 9, 2012

Related U.S. Application Data
(60) Provisional application No. 61/441,277, filed on Feb. 9, 2011.
(60) Provisional application No. 61/588,653, filed on Jan. 19, 2012.

(51) Int. Cl. G06F 17/30

(52) U.S. Cl. 707/709; 707/E17.108

(57) ABSTRACT

A method of identifying search engine optimization opportunities is disclosed. The method may include selecting a search engine optimization object associated with an entity and collecting search engine optimization data associated with the search engine optimization object. The method may also include calculating a current value of the search engine optimization object to the entity and estimating a future value of the search engine optimization object to the entity based on the collected search engine optimization data.

### CROSS-REFERENCE TO RELATED APPLICATIONS

This patent application claims priority to U.S. Provisional Application No. 61/441,277, filed on Feb. 9, 2011 and U.S. Provisional Application No. 61/588,653, filed on Jan. 19, 2012. The foregoing applications are incorporated herein by reference.

### BACKGROUND

Search engine optimization (SEO) generally describes the use of computing systems for running computing processes that collect, store and analyze search engine data in order to provide recommendations to improve visibility of a website or a web page in search engines. Search engine results may be obtained by various search strategies, such as natural, un-paid, organic, or algorithmic search results as well as for paid search algorithms of search engine marketing (SEM) target paid listings. Generally, the higher a website is located on a website listing and the more frequently a website appears in the search results list, the more visitors it will receive from the search engine's users. SEO may improve the availability of a website or other digital content to internet users.

SEO is implemented by Internet Technology (IT) professionals to improve the volume and quality of traffic to a given web page or other Internet site. Typical techniques include search terms in title tags, search terms in meta tags, search terms in body text, anchor text in inbound links, age of site, site structure, link popularity in a site's internal link structure, amount of indexable text/page content, number of links to a site, popularity/relevance of links to site and topical relevance of inbound link tags, any of which may include SEO data. Additional techniques are sometimes employed based on the search engine for which the webmaster is attempting to optimize. Since search engine algorithms and metrics are proprietary, SEO techniques are widely used to improve visibility of a web page or other online data on search engine result pages.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

A method of identifying search engine optimization opportunities is disclosed. The method may include selecting a search engine optimization object associated with an entity and collecting search engine optimization data associated with the search engine optimization object. The method may also include calculating a current value of the search engine optimization object to the entity and estimating a future value of the search engine optimization object to the entity based on the collected search engine optimization data.

Another method of identifying search engine optimization opportunities is also disclosed. The method may include searching a network for references to an entity using a search term. The method may also include obtaining a search score for a reference produced by the search, collecting value data for the search term, and collecting general web analytic data for one or more web pages unassociated with the entity based on the search term. The method may also include estimating, based on the value data, the search score, and at least some of the general web analytic data, a value associated with improving the search score.

Another method of identifying search engine optimization opportunities is also disclosed. This method may include selecting a plurality of search terms associated with an entity. For each selected search term, the method may include searching a network for references to an entity using a search term. The method may also include obtaining a search score for a reference produced by the search, collecting value data for the search term, and collecting general web analytic data for one or more web pages unassociated with the entity based on the search term. The method may also include estimating, based on the value data, the search score, and at least some of the general web analytic data, a value associated with improving the search score

These and other aspects of example embodiments of the invention will become more fully apparent from the following description and appended claims.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an embodiment of a SEO system configured to identify opportunities for search engine optimization;

FIG. 2 illustrates an embodiment of another SEO system configured to identify opportunities for search engine optimization;

FIG. 3 is a flowchart of an example method of identifying search engine optimization opportunities;

FIG. 4 is a flowchart of another example method of identifying search engine optimization opportunities;

FIG. 5 is a flowchart of another example method of identifying search engine optimization opportunities;

FIG. 6 illustrates a representation of a dashboard of a graphical interface for identifying opportunities for search engine optimizations;

FIG. 7 illustrates an embodiment of a computing system that can implement some embodiments described herein;

are all arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, may be arranged, substituted, combined, separated, and designed in a wide variety of different configurations, all of which are explicitly contemplated herein.

Generally, the disclosed embodiments relate to a method of identifying search engine optimization opportunities. In particular, in some embodiments, the method may include identifying search terms for which web pages of an entity may be optimized to improve visibility of the web pages. In some embodiments, the search terms may be identified based on the potential benefit of optimizing for the search term. For example, in some embodiments, the method may estimate a value associated with optimizing for a search term that may indicate potential increases in revenue to the entity or the value of a paid search campaign equivalent to optimizing for the search term. In some embodiments, the value for each search term may be calculated based on the current optimization of the entity's web pages for the search term and the general landscape with respect to the search term. In some embodiments, the landscape of a search term may include how competitors of the entity have optimized for the search term.

Reference will now be made to the figures wherein like structures will be provided with like reference designations. It is understood that the figures are diagrammatic and schematic representations of some embodiments and are not limiting of the present invention, nor are they necessarily drawn to scale.

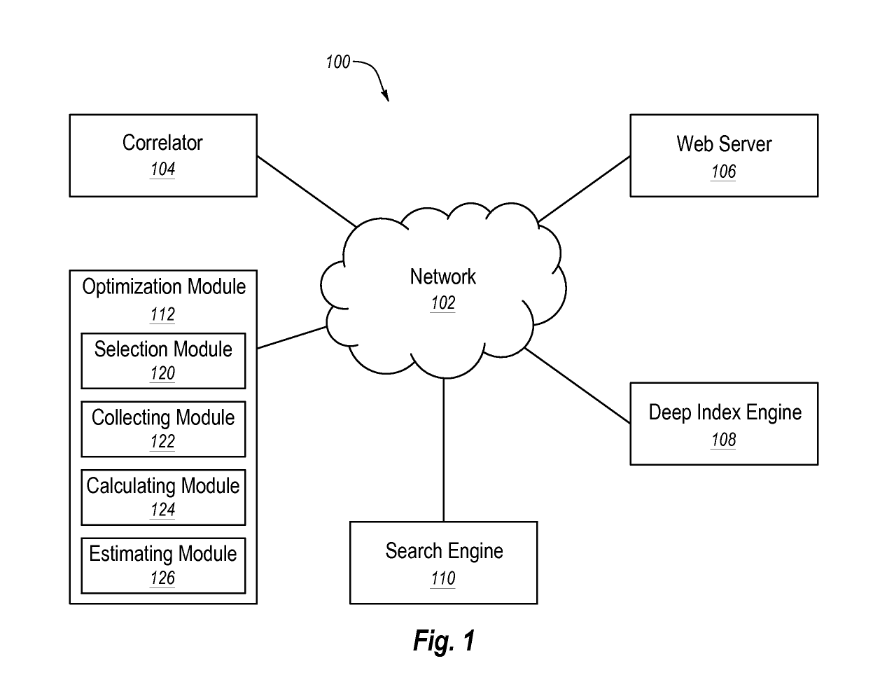

FIG. 1 illustrates an embodiment of a SEO system 100 configured to identify opportunities for search engine optimization, according to some embodiments described herein. In some embodiments, the SEO system 100 may include a network 102, which may be used to connect the various parts of the system 100 to one another, such as between a web server 106, a deep index engine 108, a correlator 104, a search engine 110, and an optimization module 112. It will be appreciated that while these components are shown as separate, the components may be combined as desired. Further, while one of each component is illustrated, the system 100 may optionally include any number of each of the illustrated components.

In some embodiments, the network 102 may include the Internet, including a global internetwork formed by logical and physical connections between multiple wide area networks and/or local area networks and may optionally include the World Wide Web (“Web”), including a system of interlinked hypertext documents accessed via the Internet. Alternately or additionally, the network 102 may include one or more cellular RF networks and/or one or more wired and/or wireless networks such as, but not limited to, 802.xx networks, Bluetooth access points, wireless access points, IP-based networks, or the like. The network 102 may also include servers that enable one type of network to interface with another type of network.

The web server 106 may include any system capable of storing and transmitting digital content, such as web pages and other digital content. The web server 106 may provide access to the web pages of a website or other digital content on the web that may be analyzed for improving SEO. For example, the web server 106 may include a computer program that is responsible for accepting requests from clients (user agents such as web browsers), and serving them HTTP responses along with optional data contents, which may include HTML documents and linked objects for display to the user. Alternately or additionally, the web server 106 may include the capability of logging some detailed information, about client requests and server response, to log files.

A website may include any number of web pages. The aggregation of visits to the various web pages within a website may be referred to as traffic. It should be noted that a web page as used herein refers to any online posting, including domains, subdomains, web posts, Uniform Resource Identifiers (“URIs”), Uniform Resource Locators (“URLs”), images, videos, or other piece of content and non-permanent postings such as e-mail and chat unless otherwise specified. A web page may be associated with an entity. An entity may be any business, corporation, partnerships, collaboration, foundation, individual, or other person or groups of people, that own, have interest in, or is otherwise affiliated with a web page.

References to a web page may include any reference to the web page that directs a visitor to the web page. For example, a reference may include text documents, such as blogs, news items, customer reviews, emails or any other text document that discusses the web page. Alternately or additionally, a reference may include a web page that includes a link to the web page. Alternately or additionally, a reference may be part of a web page that includes a link to the web page. For example, a reference may include a search result on a search engine results pages, a brief description of the web page, and a link to the web page on a social media site, a social media acknowledgement on a social media site.

In some embodiments, the deep index engine 108 may be configured to use an identified search term to perform a search of the network 102 to identify references to an entity. The deep index engine 108 may be further configured to generate a search score for references to the entity produced by the search of the network 102. This score may include a position at which references to the entity are displayed on search result pages resulting from the search of the network 102. The relative position of the references to the entity within the search results may affect how the references affect actions related to the entity.

Alternately or additionally, the deep index engine 120 may be configured to collect general web analytic data for references unassociated with the entity on the search results pages. The general web analytic data may include a search score for the references unassociated with the entity that include a position at which the references unassociated with the entity are displayed on the search results pages.

Alternately or additionally, the deep index engine 108 may be configured to crawl the search results to collect web analytics. In particular, the deep index engine 108 may be configured to crawl the search results and analyze data associated with the crawl. For example, the deep index engine 108 may determine on-page information and back link data for each reference in the search results. Alternately or additionally, the deep index engine 108 may analyze the back link data to determine the quality of the back link data. The quality of the back link data may depend on the back link data including text that relates to or describes information related to the reference associated with back link data. The quality of the back link data may also depend on a web page on which the backlink data is located and the subject matter of the web page.

A deep index engine 108 according to some embodiments is described in more detail in copending U.S. patent application Ser. No. 12/436,704 entitled COLLECTING AND SCORING ONLINE REFERENCES, filed May 6, 2009, which application is hereby incorporated by reference in its entirety.

In some embodiments, the correlator 104 may be configured to collect value data for a search term. For example, in some embodiments, the correlator 104 may determine how many visitors are directed to a web page resulting from a search using a specific search term. Alternately or additionally, the correlator 104 may determine the number of conversions on a web page resulting from a search using a specific search term. Alternately or additionally, the correlator 104 may determine an actual value for cost per click advertisements that are associated with the search term.

A correlator 104 according to some embodiments is described in more detail in co-pending U.S. patent application Ser. No. 12/574,069, filed Oct. 6, 2009 entitled CORRELATING WEB PAGE VISITS AND CONVERSIONS WITH EXTERNAL REFERENCES, which application is hereby incorporated by reference in its entirety.

The search engine 110 may be an internal or private search engine that is used for the function of producing search results that may include non-category specific search results, such as websites, and category specific search results, such as images, videos, news, shopping, realtime, blogs, books, places, discussions, recipes, patents, calculators, stocks, timelines, and others. The search engine 110 may also be a public search engine or commercial search engine, such as those search engines of Bing, Google, Yahoo, or the like.

In some embodiments, the search engine 110 may be configured to provide the search volume of a specific search term. For example, the search engine 110 may provide data that include that a search term, such as, “baby cloths” has a search volume of 5,000 searches per day. Alternately or additionally, the search engine 110 may be configured to provide data concerning the paid search value of a search term. For example, in some embodiments, the search engine 110 may provide the average value of cost per click advertisements that are associated with the search term. In other embodiments, the search engine 110 may provide the value of costs per click advertisements that are associated with the search terms for every entity or a subset of the entities that produce the advertisements.

In some embodiments, the optimization module 112 may be configured to operable couple and orchestrate work performed by the correlator 104, web server 106, deep index engine 108, and the search engine 110. Alternately or additionally, the optimization module 112 may also be configured to identifying search engine optimization opportunities for search terms as described herein.

The optimization module 112 may include various modules for implementing particular functionalities. In some embodiments, the optimization module 112 may be generic to and include a selection module 120, a collecting module 122, a calculating module 124, and an estimating module 126. The selection module 120, the collecting module 122, the calculating module 124, and the estimating module 126 may communication with, receive data from, and/or send data to one or more of the correlator 104, the web server 106, the deep index engine 108, and the search engine 110 to implement their particular functionalities.

In some embodiments, the selection module 120 may be configured to select one or more search engine optimization objects associated with an entity. The search engine optimization object may include search terms, backlinks, web pages, web page templates, or other objects that may be associated with the entity.

In some embodiments, the collecting module 122 may be configured to collect search engine optimization data associated with the search engine optimization object. In some embodiments, the search engine optimization data may include web analytic data as described herein.

In some embodiments, the calculating module 124 may calculate a current value of the search engine optimization object to the entity. In some embodiments, the calculating module 124 may collect value data for the search engine optimization object that may be used to calculate the value of the search engine optimization object. For example, the value data may include data such as the number of visits or conversions to a web page resulting at least partially from the search engine optimization object. Alternately or additionally, the value data may include the value of a paid search campaign that would produce the same number of visits to a web page as the search engine optimization object. Using the collected value data, the calculating module 124 may calculate the current value.

In some embodiments, the estimating module 126 may be configured to estimate a future value of the search engine optimization object to the entity based on the collected search engine optimization data and the current value of the search engine optimization data. In some embodiments, the future value of the search engine optimization object may represent the value of the search engine optimization object to the entity if the search engine optimization object was optimized. The estimating module 126 may use the collected search engine optimization data to determine an amount that the search engine optimization object may be optimized. Based on the how much the search engine optimization object may be optimized, the estimating module 126 may determine the future value of the search engine optimization object.

In some embodiments, the estimating module 126 may determine a cost for optimizing the search engine optimization object. In these and other embodiments, the estimating module 126 may calculate a net value that compares the future value of the search engine optimization object and the cost for optimizing the search engine optimization object to obtain the future value of the search engine optimization object.

In some embodiments, the estimating module 126 may determine search engine optimization objects that may be search engine optimization opportunities based on one or more factors, such as the current value, future value, net value, and others. In some embodiments, the estimating module 126 may present the search engine optimization opportunities to a user of the SEO system 100.

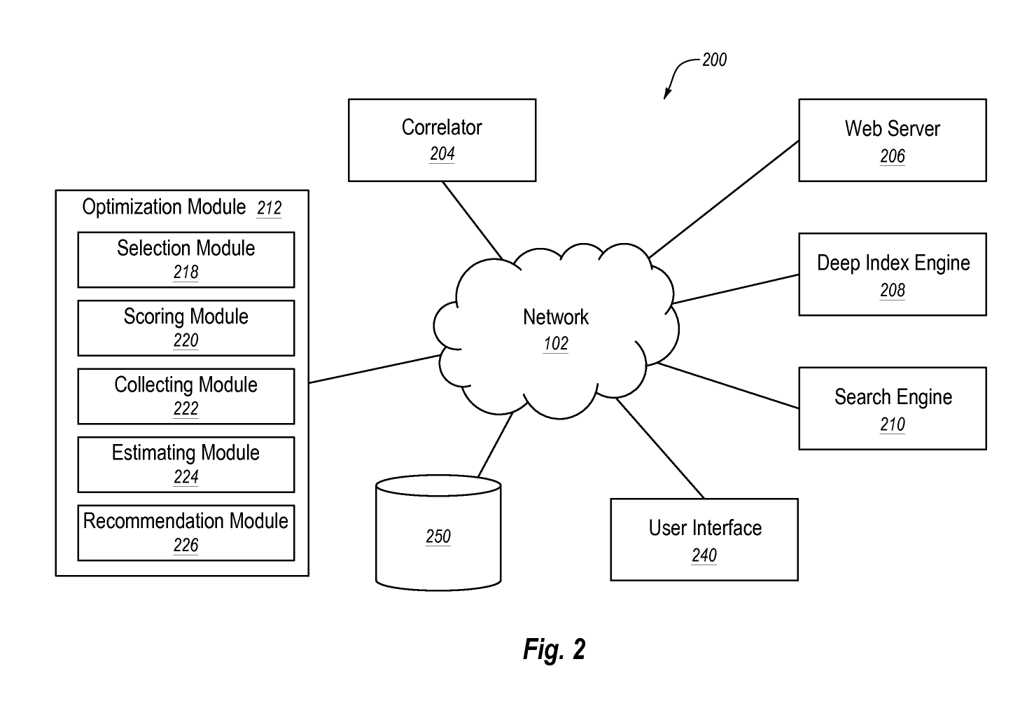

FIG. 2 illustrates another embodiment of a SEO system 200 configured to identify opportunities for search engine optimization, according to some embodiments described herein. As shown, the network 102 may operably couple a correlator 204, a web server 206, a deep index engine 208, a search engine 210, an optimization module 212, a user interface 240, and a database 250. It will be appreciated that while these components are shown as separate, the components may be combined as desired. Further, while one of each component is illustrated, the system 200 may optionally include any number of each of the illustrated components or other components.

In some embodiments, the correlator 204, the web server 206, the deep index engine 208, and the search engine 210 may operate similar to the respective correlator 104, web server 106, deep index engine 108, and search engine 110 of FIG. 1.

The optimization module 212 may include various modules for implementing particular functionalities. In some embodiments, the optimization module 212 may be generic to and include a selection module 218, a scoring module 220, a collecting module 220, an estimating module 224, and a recommendation module 226. The selection module 218, the scoring module 220, the collecting module 220, the estimating module 224, and the recommendation module 226 may communication with, receive data from, and/or send data to one or more of the correlator 204, the web server 206, the deep index engine 208, and the search engine 210 to implement their particular functionalities.

In some embodiments, the selection module 218 may be configured to select one or more search terms associated with an entity. For example, the selection module 218 may select search terms that are being actively managed in any respect by the entity. Alternately or additionally, the selection module 218 may select all search terms associated with the entity by the SEO system 200. Alternately or additionally, the selection module 218 may select search terms based on the search terms for which the entity's competitors' web pages are optimized and/or un-optimized. Alternately or additionally, the selection module 218 may select search terms based on the SEO system's 200 determination of the search terms with potential high value. Alternately or additionally, the selection module 218 may select search terms based on input from a user through the user interface 240. For example, a user may view the search terms selected by the selection module 218 through the user interface 240 and deselected selected search terms. Alternately or additionally, the user may input search terms through the user interface 240. In some embodiments, the selection module 218 may be configured to select a group of search terms from multiple groups of search terms. The search terms may be grouped based on the types of search terms discussed herein or using any other classification of search terms.

In some embodiments, the scoring module 220, the collecting module 220, and the estimating module 224 may use the one or more search terms selected by the selection module 218 to perform their particular functionalities. For ease in explanation, the particular functionalities for the scoring module 220, the collecting module 220, and the estimating module 224 are described with respect to a single search term selected by the selection module 218. However, each of the scoring module 220, the collecting module 220, and the estimating module 224 may operate to perform their particular functionality for each of the search terms selected by the selection module 218.

In some embodiments, the scoring module 220 may be configured to perform a search of the network 102 for a reference to the entity based on the search term selected by the selection module 218. After performing the search, the scoring module 220 may identify a reference to the entity within the search results produced by the search. For example, in some embodiments, the scoring module 220 may identify a reference to a web page of an entity within a search results page. The scoring module 220 may also be configured to obtain a search score for the reference produced by the search for the search term. In some embodiments, the search score may represent the location of the reference with respect to other objects produced by the search.

In some embodiments, the scoring module 220 may determine a search score for the reference produced by the search based on one or more factors other than or including the location of the reference. For example, in some embodiments, the search score may depend on the geographic location where the search is performed. Alternately or additionally, the search score may depend on other factors, such as, previous searches performed by a user, previous web pages viewed by the user, previous links followed by the user, previous actions performed on one or more web pages by the user, or other actions performed by a user.

In some embodiments, the scoring module 220 may obtain a search score for the reference from the database 250. In these and other embodiments, a search score for the reference may have been previously obtained and stored in the database 250.

In some embodiments, the collecting module 222 may be configured to collect value data for the search term selected by the selection module 218 with respect to the reference. The value data for the search term may be data to allow the optimization module 212 and more specifically the estimating module 224, to determine a value of the search term to the entity with respect to the reference.

In some embodiments, a value of the search term to an entity may represent the value that the entity may obtain by optimizing for that search term. For example, an entity may pay one dollar per click in a paid advertising campaign. If the entity were to optimize for the search term, the reference to the entity, such as a link to a web page of the entity, may be more visible when the search term is searched, resulting in the same number of visits to the entity's web page as was obtained from the paid advertisement. After optimizing for the search term, the entity would not have to pay the advertisement fee to achieve similar web page traffic. The potential savings on advertisement fees may represent the value of the search term to the entity with respect to the reference. In other embodiments, the value of the search term with respect to the reference may be equal to the value of increased traffic to an entity's web page as a result of optimizing for the search term. For example, by optimizing for the search term, the reference to an entity's web page may be better positioned in the search results page, thereby resulting in more click-throughs and more traffic on the entity's web page, which may be determined, based on the value of a visit to the entity's web page.

In some embodiments, the value data collected by the collecting module 222 may include a search volume of the search term selected by the selection module 218 and the average value of costs per click advertisements for the search term. In these and other embodiments, the average value of costs per click advertisements may be collected from a search engine API, such as through an API of the search engine 210. Alternately or additionally, the value data may include an actual value of costs per click advertisements for the search term. In these and other embodiments, the actual value of costs per click may be collected from a user through the user interface 240, it may be stored on the database 250, and/or it may be determined based on other information associated with the entity that is collected.

Alternately or additionally, the value data may include an estimated click-through rate of the reference to the entity based on the search score and the number of searches performed for the search term. Alternately or additionally, the value data may include the number of visitors directed to a web page resulting from a search using the search term and the value of a visit to the web page to the entity. Alternately or additionally, the value data may include the number of conversions on a web page resulting from a search using the search term and the value of a conversion on the web page to the entity. Alternately or additionally, the value data may include an actual value of visits and conversion resulting from the search term.

In some embodiments, the collecting module 222 may also be configured to collect general web analytic data and entity web analytic data. The collecting module 222 may collect the entity web analytic data for the reference produced by searching for the search term selected by the selection module 218. The collecting module 222 may also collect general web analytic data for one or more web pages unassociated with the entity. In some embodiments, the web pages unassociated with the entity may be web pages produced by searching for the search term selected by the selection module 218. In these and other embodiments, the number of web pages selected for collecting general web analytic data may vary and may include the web pages that have the highest search scores, such as web pages with the top 5, 10, or 15 highest scores. In other embodiments, the number of web pages selected for collecting general web analytic data may include all web pages with a search score higher than or with a predetermined range around the search score of the reference.

In general, both the general web analytic data and entity web analytic data may include a search score, on-page information, social media data, back link data, and/or other web analytic data. In some embodiments, the social media data may include the number of acknowledgements a reference or web page receives from social media. For example, the number of acknowledgements to a reference or web page may be the number of times the reference or web page is liked in a social network, such as Facebook, or referenced in a micro blog, such as Twitter. Alternately or additionally, the social media data may indicate how often a reference or web page is referenced in social media, links from social media to the reference or web page or other ways that the reference or web page is associated with social media. In some embodiments, the back link data may include the number of total backlinks and the quality of the backlinks.

In some embodiments, the estimating module 224 may be configured to estimate a value associated with improving the search score of the reference based on the collected value data, the search score, and at least some of the collected general web analytic data. In these and other embodiments, the estimating module 224 may use the collected general web analytic data to determine a search landscape for the search term. The search landscape for the search term may indicate a level at which entities have optimized for the search term. The estimating module 224 may be configured to determine a level of difficulty for the entity to optimize the reference with respect to the search landscape for the search term. In some embodiments, the estimating module 224 may have predefined levels of difficult and criteria for determining placement in each of the levels. For example, in some embodiments, there may be three levels of difficulty, referenced as low, medium, or high difficulty.

As an example, in these and other embodiments, the criteria for low level of difficulty may be if the collected general and entity web analytic data illustrates that the reference has more back links and more quality back links than 70 percent of the web pages for which general web analytic data was collected. The criteria for medium level of difficulty may be if the reference has less back links but more quality back links than a majority of the web pages for which general web analytic data was collected. The criteria for high level of difficulty may be if the reference has less back links and less quality back links than a majority of the web pages for which general web analytic data was collected. In other embodiments, the estimating module 224 may rank the difficulty using other standards or the same standard with more or less than three levels of difficulty.

In some embodiments, based on the difficulty level for the entity to optimize for the search term, the estimating module 224 may determine a target score based on the search score. In some embodiments, the target score may be adjusted minimally from the search score if the difficulty level is high, modestly if the difficulty level is medium, and the most if the difficulty level is low. For example, if the search score was 20, the target score may be set at 15 if the difficulty level is high, at 10 if the difficulty level is medium, and at 5 if the difficulty level is low. Alternately or additionally, the amount that the target score is adjusted away from the search score may depend on the value of the target score. Alternately or additionally, the target score may be determined based on user input from the user interface 240. Alternately or additionally, the difficultly level and the amount to adjust the target score may be determined based on user input. For example, in some embodiments, a user may indicate a specific target score for a reference. In some embodiments, a user may indicate a level of aggressiveness for determining target scores. In these and other embodiments, the level of aggressiveness may determine how may each target scored is varied from the search score based on the level of difficultly. For example, for a conservative setting, the target score for a reference with a low level of difficulty may be adjusted by ten from the search score. For an aggressive setting, the target score for the same reference may be adjusted by twenty from the search score.

After determining the target score, the estimating module 224 may estimate a value, based on the value data, associated with improving the search score so that it equals the target score. For example, assume the reference was a link to a web page in a search results page where the estimated search volume for the search term that produces the reference is 1,000 searches per day. If the search score of the reference was 10 with a click-through rate of 5% and the target score was 5 with a click-through rate of 20% and the search score was improved to equal the target score, then an increase in visits to the web page may be 150 visit per day based on the search volume multiplied by click-through rate of the target score minus the search volume multiplied by click-through rate of the search score. The value associated with improving the search score may be the value of a visit to the web page multiplied by the increase in the number of visits. So, if the value of a visit is five dollars, then the value associated with improving the search score may be 750 dollars.

In some embodiments, the estimating module 224 may also be configured to estimate costs associated with improving the search score and calculate a net benefit based on the estimated costs and the estimated value. For example, in some embodiments, the estimating module 224 may estimate a cost associated with increasing the number of backlinks to a web page to increase the search score of the web page. Using the estimated cost associated with increasing the number of backlinks and the estimated value gained by the web page by increasing the number of backlinks, a net benefit to the web page may be calculated.

In some embodiments, the estimating module 224 may obtain actual values associated with improving the search score after the entity optimizes for the search term. The estimating module 224 may compare the actual value to the estimated value to obtain a comparison value for the search term. For example, in some embodiments, after optimizing for the search score, a user may provide and/or the SEO system 200 may calculate, an increase in revenue generated from the search term and compare the actual value to the estimated value. In other embodiments, the actual value may be a value that the entity saves based on a cost per click basis.

The optimization module 212 may use the comparison value for the search term to estimate values for other search terms. For example, in some embodiments, the selection module 218 may select a second search term. The scoring module 220 may obtain a second search score for a second reference to the entity using the second search term. The collecting module 222 may collect second value data for the second search term with respect to the second reference. The estimating module 224 may estimate, based on the second value data, the second search score, and the comparison value, a second value associated with improving the search score. By using the comparison value generated by the search term, the optimization module 212 may adjust the estimate of the second value and thereby achieve a better estimate.

In some embodiments, the recommendation module 226 may be configured to generate a report indicating the estimated value. In some embodiments, the report may present recommendations for improving the search score to achieve the value associated with improving the search score. Alternately or additionally, the report may include the net benefit to the entity.

In some embodiments, the SEO system 200 may provide ways for the SEO system 200 to verify that recommendations have occurred. For example, the SEO system 200 may perform an audit to determine if the optimizations have occurred. The SEO system 200 may also set the recommendations as tracked items to determine when the optimizations occur and track the actual values produced from the optimizations.

As indicated herein, the selection module 218 may select one or more search terms associated with the entity. When the selection module 218 selects multiple search term for the entity, each search term may be processed by the scoring module 220, the collecting module 222, and the estimating module 224 to estimate a value associated with improving the search score with a reference associated with each search term.

In some embodiments, the recommendation module 226 may be configured to designate some or all of the selected search terms and the estimated values associated with these search terms for estimating a total estimated value of the designated search terms. The estimated total value may indicate the total value to an entity that may be achievable for the search terms. For example, the estimated total value may indicate the value to an entity if all of the references to the entity associated with the search terms were to achieve the highest search score possible. A reference having the highest search score possible may indicate that the reference has the most visibility. For example, a reference with the highest search score possible may have the most visible position in a search results page, such as the first position.

In these and other embodiments, the recommendation module 226 may estimate a capture value of the designated search terms based on the estimated values for the designated search terms. The estimated capture value may indicate a value to an entity that may be achievable from the designated search terms with respect to the search landscape of the designated search term. In some embodiments, the estimated capture value may be a compilation of all of the values associated with improving the search score of the designated search terms as estimated by the estimation module 224.

In some embodiments, the recommendation module 226 may present a comparison of the total value and the captured value to a user. The presentation may be audible, visual, or using some other manner of communication.

In some embodiments, the recommendation module 226 may be configured to designated some or all of the multiple selected search terms for sorting based on a correlation between the estimated value of each designated search term and at least some of the web analytic data for each designated search term. For example, in some embodiments, the recommendation module 226 may use the difficultly level associated with each designated search term as determined by the collecting module 222 for sorting the designated search terms. In these and other embodiments, the recommendation module 226 may sort the designated search terms based on the level of difficulty and the estimated value for each designated search term. For example, the recommendation module 226 may sort the designated search terms to present designated search terms with the lowest level of difficulty and the highest estimated values.

In some embodiments, the recommendation module 226 may be configured to recommend search terms with estimated values above a threshold as search engine optimization opportunities. The threshold may be predetermined, determined based on user input, or on some averaging, weighted averaging, or otherwise of the estimated values of the search terms.

In some embodiments, the recommendation module 226 may be configured to identifying a current value for each search term based on the value data for each search term and identifying each search term with a potential above a threshold to have a future value less than the current value of the respective search term based on the general and entity web analytic data for the respective search term. Identifying each search term with a potential above a threshold to have a future value less than the current value may include determining a search landscape for the search term and, based on the search landscape, determining the probability that web pages other than the web page of the entity may be optimized and reduce the search score of the reference to the entity.

In some embodiments, the optimization module 212 may be configured to identify optimization opportunities for different search platforms. For example, searches performed on a personal computer (PC) may produce different search results than searches performed on a mobile device, such as a smart phone, tablet computer, gaming device, or other mobile device.

In these and other embodiments, a PC and a mobile device may be different search platforms. In identifying optimization opportunities for different search platforms, the optimization module 212 may perform searches, collect value data, and web analytic data for the specific search platform. In other embodiments, the optimization module 212 may be configured to identify optimization opportunities for multiple search platforms. In these and other embodiments, the optimization module 212 may perform searches, collect value data, and web analytic data for multiple search platforms and integrate all of the searches and collected data. In these and other embodiments, the optimization module 212 may provide for sorting based on the different search platforms or indicate optimizations ideal for all or one or more of the multiple search platforms.

In some embodiments, the selection module 218, the scoring module 220, the collecting module 222, the estimating module 224, and the recommendation module 226 may perform their functions using and/or in conjunction with one or more of the correlator 204, the web server 206, the deep index engine 208, and the search engine 210.

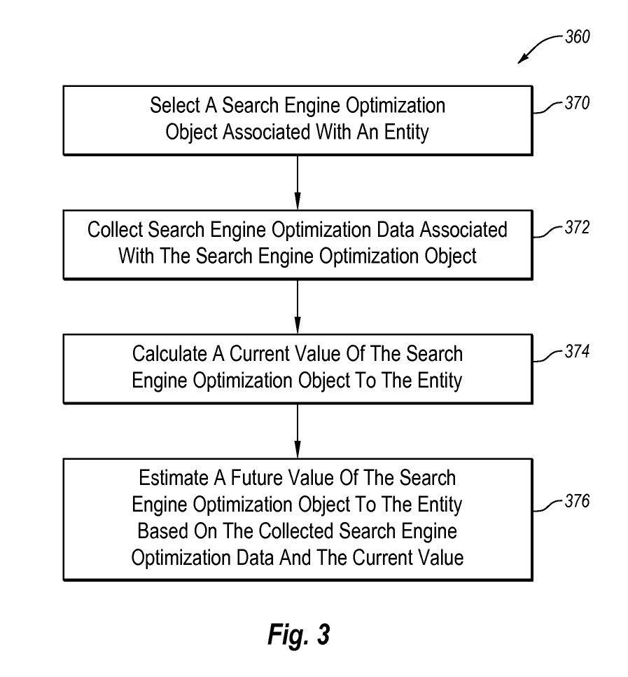

FIG. 3 is a flowchart of an example method 360 of identifying search engine optimization opportunities, arranged in accordance with at least some embodiments described herein. The method 360 may be implemented, in some embodiments, by a SEO system, such as the SEO system 100 of FIG. 1.

The method 350 may begin at block 370, in which a search engine optimization object associated with an entity may be selected. In some embodiments, the search engine optimization object may be a search term, backlink, web page, web page template, or other object that may be associated with search engine optimization.

At block 372, search engine optimization data associated with the search engine optimization object may be collected. In some embodiments, collecting search engine optimization data may include collecting web analytic data. For example, in embodiments, general web analytic data for one or more web pages unassociated with an entity based on a search term may be collected.

At block 374, a current value of the search engine optimization object to the entity may be calculated. In some embodiments, calculating a current value of the search engine optimization object may include searching a network for references to an entity using a search term, obtaining a search score for a reference produced by the search and collecting value data for the search term with respect to the reference.

At block 376, a future value of the search engine optimization object to the entity may be estimated based on the collected search engine optimization data and the current value. In some embodiments, the future value of the search engine optimization object may be estimated based on the general web analytic data, the value data, and the search score obtained in block 374 and block 372.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

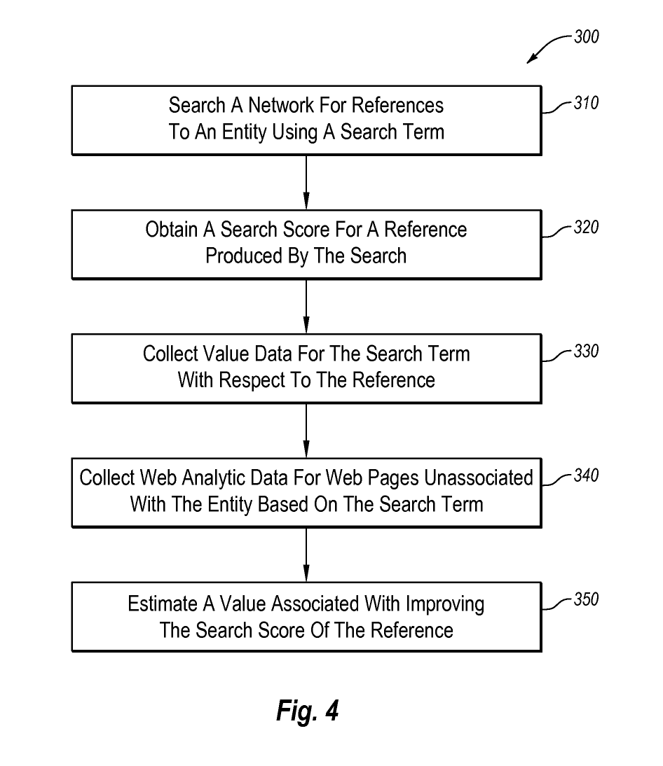

FIG. 4 is a flowchart of an example method 300 of identifying search engine optimization opportunities, arranged in accordance with at least some embodiments described herein. The method 300 may be implemented, in some embodiments, by a SEO system, such as the SEO system 200 of FIG. 2.

The method 300 may begin at block 310, in which a network may be searched for references to an entity using a search term. After performing the search, a reference to the entity may be identified within the search results produced by the search. For example, in some embodiments, a reference to a web page of an entity may be identified within a search results page. In these and other embodiments, the reference may be a link to a web page of the entity and/or other information about the web page that may be displayed by a search engine as a result of searching for the search term.

At block 320, a search score for a reference produced by the search may be obtained. In some embodiments, the search score may represent the location of the reference with respect to other objects produced by the search. More particularly, in some embodiments, the search score may represent the location of the reference with respect to other references in a search results page. For example, if the reference was located at the top of the search results page in the first position for unpaid or organic search results, the reference may be given the highest search score or a search score of one.

At block 330, value data for the search term with respect to the reference may be collected. In some embodiments, the value data may include a paid search value of the search term. Alternately or additionally, the value data may include a click through rate of the reference. Alternately or additionally, the value data may include a search volume of the search term. Alternately or additionally, the value data may include an average value per visit to a website of the entity resulting from the search term. Alternately or additionally, the value data may include an average value per conversion on the website of the entity resulting from the search term. In one or more of the above embodiments, a user may supply the value data or the value data may be collected from other sources.

In some embodiments, the value data may be based on actual search engine optimization values associated with the search term. In these and other embodiments, the actual value of costs per click may be collected from a user, a database 250, and/or it may be determined based on other collected information associated with the entity. In some embodiments, the value data may include an actual value of visits and conversions resulting from the search term.

At block 340, general web analytic data for one or more web pages unassociated with the entity based on the search term may be collected. In some embodiments, the web pages unassociated with the entity may be web pages produced by searching for the search term. In these and other embodiments, the number of web pages selected for collecting general web analytic data may vary and may include the web pages that have the highest search scores, such as web pages with the top 5, 10, or 15 highest scores. In other embodiments, the number of web pages selected for collecting general web analytic data may include all web pages with a search score higher than or with a predetermined range around the search score of the reference.

In general, the general web analytic data may include a search score, on-page information, and/or back link data for each of the web pages unassociated with entity. In some embodiments, the back link data may include the number of total backlinks and the quality of the backlinks.

At block 350, a value associated with improving the search score may be estimated based on the value data, the search score, and some of the general web analytic data.

Alternately or additionally, the method 300 may include selecting the search term from one of a plurality of groupings of search terms. Alternately or additionally, the method 300 may include generating a report indicating the estimated value and including recommendations for improving the search score. In some embodiments, the report may include links to additional search engine optimization opportunities for the search term.

Alternately or additionally, the method 300 may include calculating a target search score using the general web analytic data and estimating the value associated with improving the search score based on the target search score, the search score, and the value data. In some embodiments, the value may be estimated based on the value data and a difference between the search score and a target search score received from a user. In some embodiments, the method 300 may include estimating costs associated with improving the search score and calculating a net benefit based on the estimated costs and the estimated value.

Alternately or additionally, the method 300 may include collecting entity web analytic data regarding the reference produced by the search and estimating the value based on the entity web analytic data, the value data, the search score, and at least some of the general web analytic data. In some embodiments, the entity web analytic data may include a search score, on-page information, and/or back link data for the web page associated with the reference.

Alternately or additionally, the method 300 may include estimating a comparison value associated with improving the search score based on the comparison of the estimated value to an actual value associated with improving the search. In some embodiments, the method 300 may include actions that utilize the comparison. For example, in some embodiments, the method 300 may include obtaining a second search score for a second reference to the entity using a second search term. Second value data for the second search term with respect to the second reference may be collected and a second value associated with improving the second search score may be estimated based on the second value data, the second search score, and the comparison value.

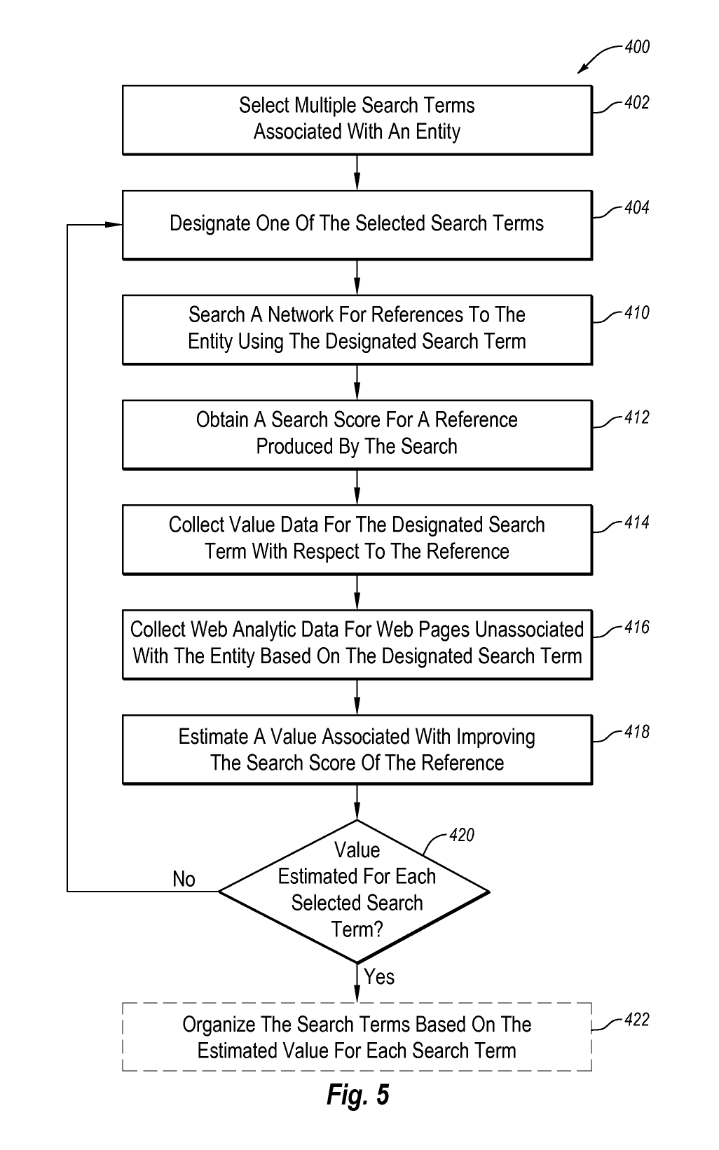

FIG. 5 is a flowchart of an example method 400 of identifying search engine optimization opportunities, arranged in accordance with at least some embodiments described herein. The method 400 may be implemented, in some embodiments, by a SEO system, such as the SEO system 200 of FIG. 2.

The method 400 may begin at block 402, in which multiple search terms associated with an entity may be selected. For example, in some embodiments, search terms that are being actively managed in any respect by the entity may be selected.

Alternately or additionally, all or only a portion of the search terms associated with the entity may be selected. Alternately or additionally, search terms may be selected based on the search terms for which the entity's competitors' web pages are optimized and/or un-optimized. Alternately or additionally, search terms may be selected based on input from a user.

At block 404, one of the selected search terms may be designated. In some embodiments, the method 400 may proceed with blocks 410, 412, 414, 416, and 418 to estimate a value associated with improving a search score for a reference obtained by searching for the designated search term. In some embodiments, the blocks 410, 412, 414, 416, and 418 may be similar to the blocks 310, 320, 330, 340, and 350, respectively, in FIG. 4.

At block 410, a network may be searched for references to the entity using the designated search term. At block 412, a search score for a reference produced by the search may be obtained. At block 414, value data for the designated search term with respect to the reference may be collected.

At block 416, general web analytic data for one or more web pages unassociated with the entity based on the designated search term may be collected. In some embodiments, the one or more websites from which the web analytic data is collected may be different for each search term.

At block 418, a value associated with improving the search score may be estimated based on the value data, the search score, and at least some of the general web analytic data.

At block 420, it may be determined if a value has been estimated for each selected search term. When a value has been estimated for each search term selected in block 402, the method 400 may end or proceed to optional block 422. When a value has not been estimated for a search term selected in block 402, the method 400 may proceed to block 404 where the search term may be designated and blocks 410, 412, 414, 416, and 418 may be performed with respect to the designated search term. In some embodiments, the blocks 410, 412, 414, 416, and 418 may be performed with respect to each search term in a linear fashion. In other embodiments, the blocks 410, 412, 414, 416, and 418 may be performed with respect to each search term in a parallel manner.

The method 400 may optionally include block 422, at which the selected search terms may be organized based on the estimated value for each search term. For example, in some embodiments, the selected search terms may be organized by sorting the search terms based on a correlation between the estimated value of each search term and at least some of the web analytic data for each search term. Alternately or additionally, the search terms may be organized based on search terms with values above a threshold. In these and other embodiments, the search terms with values above a threshold may be recommended as search engine optimization opportunities.

Alternately or additionally, the method 400 may include calculating a total value of all the selected search terms based on the value data of each search term and calculating a capture value of all the selected search terms based on all the estimated values. In these and other embodiments, a comparison of the total value and the captured value may be presented to a user.

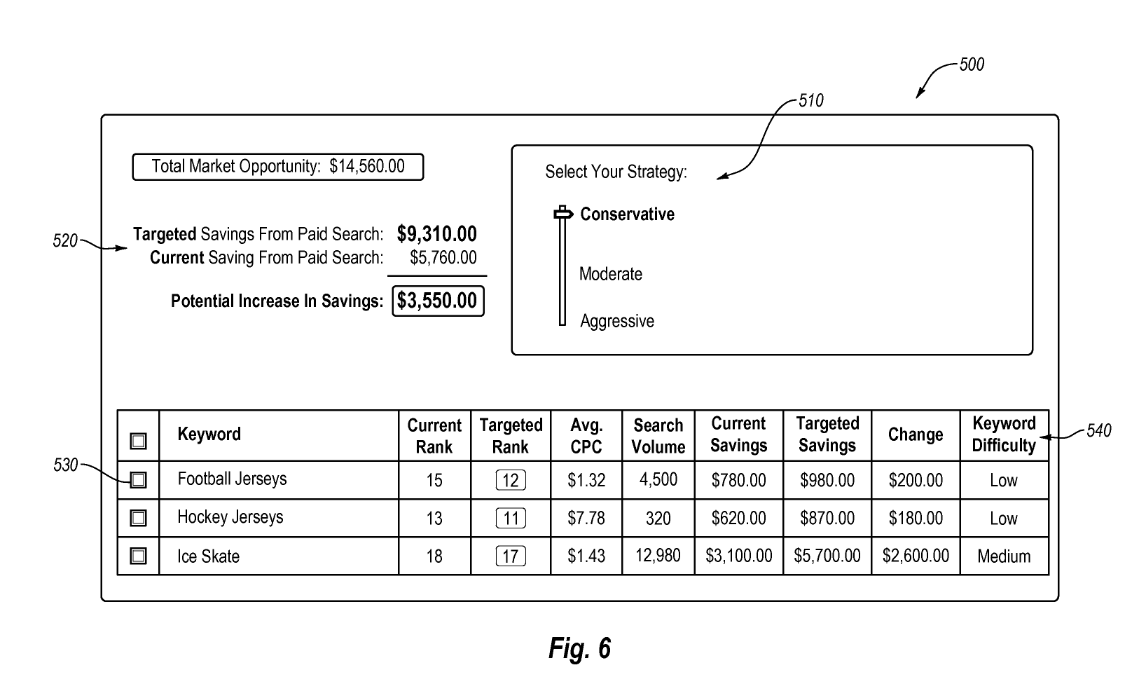

FIG. 6 illustrates a representation of a dashboard 500 of a graphical interface for identifying opportunities for search engine optimizations, arranged in accordance with at least some embodiments described herein.

The dashboard 500 illustrates a chart 540 that may include information about selected search terms for an entity, referred in the chart 540 as keywords. The chart 540 may include information, such as, the keywords, a current rank (search score) for a reference to an entity produced by searching the keyword. The chart 540 may further includes information, such as, the target rank (target search score), the average cost per click in paid search for the keyword, search volume for the keyword, a targeted savings (a value) associated with improving the search score to the target rank, the difficultly level of improving the current rank to the target rank, as well as other information.

The dashboard 500 also illustrates a strategy selection area 510 that allows a user to select a level of aggressiveness for determining target ranks for selected keywords. In these and other embodiments, the level of aggressiveness may determine how much a target rank is varied from a current rank for a given keyword.

The dashboard 500 also illustrates a comparison area 520 that illustrates the total potential savings of the keywords within the dashboard 500 to the entity if each keyword achieved a highest possible rank. The savings refers to savings the entity may obtain by relying on organic search traffic instead of paid search traffic. The comparison area 520 also illustrates a current savings for the entity based on the current level of optimization of the keywords in the dashboard 500, a targeted savings for the entity based on a prescribed level of optimization that achieves the targeted ranks for the keywords, and the potential increase in savings to the entity being the difference between the current savings and the targeted savings. The dashboard 500 also illustrates a keyword selections area 530, where a user may deselect keywords to remove the keywords from the dashboard 500.

Some embodiments described herein include a computer program product having computer-executable instructions for causing a computing system having the computer program product to perform a computing method of the computer-executable instructions for identifying search engine optimization opportunities. The computing method may be any method described herein as performed by a computing system. The computer program product may be located on a computer memory device, which may be removable or integrated with the computing system.

Some embodiments described herein include a computing system capable of performing the methods described herein. As such, the computing system may include a memory device that has the computer-executable instructions for performing the method.

In some embodiments, a computing device, such as a computer or memory device of a computer, may include a selection module, a scoring module, a collecting module, an estimating module, and a recommendation module. These modules may be configured to perform any of the methods described herein. In addition, these modules may be combined into a single module or on a single platform. In some embodiments, a computer program product may include one or more algorithms for performing any of the methods of any of the claims.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for describing particular embodiments only, and is not intended to be limiting.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In some embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

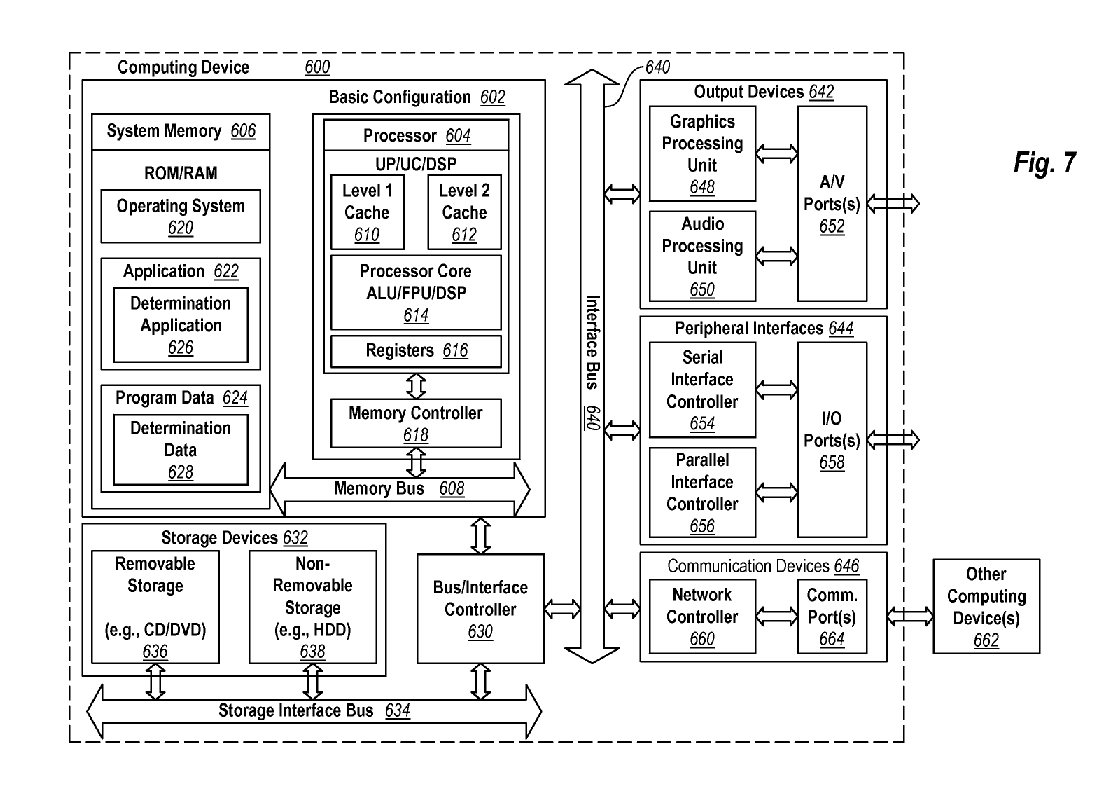

FIG. 7 shows an example computing device 600 that is arranged to perform any of the computing methods described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating-point unit (FPU), a digital signal-processing core (DSP Core), or any combination thereof. An example memory controller 618 may also be used with processor 604, or in some implementations, memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include a determination application 626 that is arranged to perform the functions as described herein including those described with respect to methods described herein. The determination application 626 may correspond to the estimating module 224 of FIG. 2, for example. Program data 624 may include determination data 628, such as value data or web analytic data that may be useful for estimating a value associated with improving the search score of a reference. In some embodiments, application 622 may be arranged to operate with program data 624 on operating system 620.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652.

Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations. The computing device 600 may also be any type of network computing device. The computing device 600 may also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium which may be used to carry or store desired program code means in the form of computer-executable instructions or data structures and which may be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data that cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” and the like include the number recited and refer to ranges which may be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims. All references recited herein are incorporated herein by specific reference in their entirety.

1. A method of identifying search engine optimization opportunities, the method comprising:
selecting a search engine optimization object associated with an entity;
collecting search engine optimization data associated with the search engine optimization object;
calculating a current value of the search engine optimization object to the entity; and
estimating a future value of the search engine optimization object to the entity based on the collected search engine optimization data.

2. The method of claim 1, wherein the search engine optimization object is a search term.

3. The method of claim 2, wherein calculating a current value of the search term comprises:
searching a network for references to an entity using a search term; and
obtaining a search score for a reference produced by the search.

4. The method of claim 3, wherein calculating a current value of the search term further comprises collecting value data for the search term with respect to the reference.

5. The method of claim 4, wherein collecting search engine optimization data associated with the search engine optimization object comprises collecting general search engine optimization data for one or more web pages unassociated with the entity based on the search term.

6. The method of claim 5, wherein the future value of the search term is estimated based on the general search engine optimization data, the value data, and the search score.

7. A method of identifying search engine optimization opportunities, the method comprising:
searching a network for references to an entity using a search term;
obtaining a search score for a reference produced by the search;
collecting value data for the search term with respect to the reference;
collecting general web analytic data for one or more web pages unassociated with the entity based on the search term; and
estimating, based on the value data, the search score, and at least some of the general web analytic data, a value associated with improving the search score.

8. The method of claim 7, further comprising selecting the search term from one of a plurality of groupings of search terms.

9. The method of claim 7, further comprising generating a report indicating the estimated value and including recommendations for improving the search score.

10. The method of claim 9, wherein the report includes links to additional search engine optimization opportunities for the search term.

11. A method of claim 7, further comprising calculating a target search score using the general web analytic data, wherein estimating the value associated with improving the search score is based on the target search score, the search score, and the value data.

12. The method of claim 7, further comprising collecting entity web analytic data regarding the reference produced by the search, wherein the value is estimated based on the entity web analytic data, the value data, the search score, and at least some of the general web analytic data.

13. The method of claim 7, further comprising estimating a comparison value associated with improving the search score based on the comparison of the estimated value to an actual value associated with improving the search.

14. The method of claim 13, further comprising
obtaining a second search score for a second reference to the entity using a second search term;
collecting second value data for the second search term with respect to the second reference; and
estimating, based on the second value data, the second search score, and the comparison value, a second value associated with improving the second search score.

15. The method of claim 7, further comprising estimating costs associated with improving the search score and calculating a net benefit based on the estimated costs and the estimated value.

16. The method of claim 7, wherein the value data comprises one or more of a paid search value of the search term, a click through rate of the reference, a search volume of the search term, an average value per visit to a website of the entity resulting from the search term, or an average value per conversion on the website of the entity resulting from the search term.

17. The method of claim 16, wherein one or more of the paid search value of the search term, the click through rate of the reference, the search volume of the search term, the average value per visit, or the average value per conversion, are received from a user.

18. The method of claim 7, wherein the value data is based on actual search engine optimization values associated with the search term.

19. The method of claim 7, wherein the value is estimated based on the value data and a difference between the search score and a target search score received from a user.

20. The method of claim 7, wherein the estimated value is different for different search platforms.

21. The method of identifying search engine optimization opportunities, the method comprising:
selecting a plurality of search terms associated with an entity, wherein for each search term, the method comprises:
searching on a network for references to the entity using the search term;
obtaining a search score for a reference produced by the search;
collecting value data for the search term with respect to the reference;
collecting web analytic data regarding one or more websites unassociated with the entity based on the search term; and
estimating, based on the value data, the search score, and at least some of the general web analytic data, a value associated with improving the search score.

22. The method of claim 21, wherein the one or more websites from which the web analytic data is collected are different for each search term.

23. The method of claim 21, further comprising sorting the search terms based on a correlation between the estimated value of each search term and at least some of the web analytic data.

24. The method of claim 21, further comprising recommending search terms with values above a threshold as search engine optimization opportunities.

25. The method of claim 21, further comprising:
identifying a current value for each search term based on the value data for each search term; and
identifying each search term with a potential above a threshold to have a future value less than the current value of the respective search term based on the web analytic data for the respective search term.

26. The method of claim 21, further comprising selecting the keywords from a plurality of groups of keywords.

27. The method of claim 21, further comprising:
estimating a total value of two or more of the search terms based on the value data of each search term;
estimating a capture value of the two or more search terms based on all the estimated values; and
presenting a comparison of the total value and the captured value to a user.
